(19) United States
(12) Patent Application Publication
(10) Pub. No.: US 2017/0050891 A1
(43) Pub. Date: Feb. 23, 2017

(54) TETRA VERMI COMPOST CONTAINER AND METHOD FOR COMPOSTING AGRICULTURAL WASTE

(71) Applicants: Kishorilal Ramnath Dhoot, Aurangabad (IN); Kamlesh Kishorilal Dhoot, Aurangabad (IN)

(72) Inventors: Kishorilal Ramnath Dhoot, Aurangabad (IN); Kamlesh Kishorilal Dhoot, Aurangabad (IN)

(21) Appl. No.: 15/086,940

(22) Filed: Mar. 31, 2016

Related U.S. Application Data
(63) Continuation of application No. 13/261,053, filed on Sep. 12, 2012, now abandoned.

(30) Foreign Application Priority Data
Feb. 6, 2009 (IN) PCT/IN2009/000312

(51) Int. Cl. C05F 17/00; C05F 3/06; C05F 17/02; C05F 3/00

(52) U.S. Cl. CPC C05F 17/0009; C05F 3/00; C05F 3/06; C05F 17/027; C05F 17/0045; C05F 17/0258; C05F 17/0276

(57) ABSTRACT

A tetra vermi compost container and a method for composting in a container made from a flexible fabric with walls secured by rope. Support pockets affixed to the exterior of the sidewalls for receiving support poles. Apertures in the sidewalls vent the container. Vermi wash or leachate drains through an aperture in the bottom wall into a drainage pipe and the free end of the pipe empties into a cup installed in a pit within the work surface. The compost method yields manure. The tetra vermi compost container is collapsible so that it can be easily assembled and disassembled for operation at multiple sites and for storing agricultural waste.

### CROSS-REFERENCE TO RELATED APPLICATIONS

This application is a continuation of application Ser. No. 13/261,053 filed Sep. 12, 2012, and claims the benefit of PCT/IN2009/000312 with an International Priority Date of Feb. 6, 2009.

### FIELD OF THE INVENTION

This invention relates to the field of devices and methods for composting waste into manure.

### BACKGROUND

The prior art cited below are relevant to the described device and method:

U.S. Pat. No. 6,488,733, by Kalra, et al., discloses methods of composting employing pits which are line with bricks (see e.g.: Col. 3, Line 4, Lines 20-24). The device used for composting requires a fixed, permanently dug pits. Accordingly, the device is not intended to be portable.

U.S. Patent Applications, Pub. Nos.: US 20060101882 A1 (see e.g., Col. 2-& 34) and US 20040191288 by AlKhanuja, et al., (see e.g., Col. 2-& 34) disclose the use of animal urine for composting in pits lined with bricks and is, therefore, not intended to be portable.

U.S. Pat. No. 7,141,169 by Koehler discloses composting sewage in an apparatus, comprising the use of tanks and piping therefor. It follows that this device is not intended to be portable (see, e.g., Col. 2, Lines 15-23).

U.S. Pat. No. 6,576,462 by Thompson discloses a vermi culture composting device for organic/kitchen waste which relies upon sunlight to partially control the temperature for composting. The container for composting is painted in opposed dark and light colors for absorbing or reflecting sunlight. The device is difficult to be moved from its installation site and not intended to be portable.

FR. 2913014 by Lauren discloses employment of a plurality of tanks with perforated bottoms and covered with air holes and dendrodrilus rubidus worm for composting. The device structure lacks ease of assembly and disassembly and, as a consequence, is not intended to be portable.

U.S. Pat. No. 7,018,831, by Gitt, relates to a composting apparatus which comprises a plurality of stackable composting drawers and a plurality of receivers, each receiver is arranged under one unit of the drawers. This apparatus is not intended to be portable.

### SUMMARY

Disclosed is a vermi composting bed of the type disposed upon a work surface of dirt or soil for receiving therein waste for composting and from which is drained vermi wash. The bed comprises a stitchless, heat-sealed, composite fabric comprising four layers of UV-stabilized LDPE layers coated for heat extrusion; and three HDPE substrate layers of woven fabric layers; each of said HDPE layers being disposed between two of said LDPE layers. There is a main panel made of the fabric which is 16 feet, 9 inches, by 2 feet. There are two side panels each 12 feet, 9 inches, by 2 feet. The main panel and the two side panels form the bed of 12 feet in length by 4 feet wide by 2 feet high defining the walls of the bed with an internal volume of 96 cubic feet open for receiving therein the waste for composting. The exterior walls of the side panels are green and the interior walls which defining the volume of the bed are snow white. Rope is disposed along and secured to each of the upper longitudinal marginal edge of each of the panels. The upper longitudinal marginal edges of the panels define the opening. There are fourteen pockets. Each of the pockets are comprised of the composite fabric and affixed to the exterior walls of the panels and have a U-shaped opening at one end thereof and is closed at the end opposed to the U-shaped opening. The closed end is secured to the panel by the rope. There are fourteen round, straight, 39 inch long wooden poles. The work surface has holes at predetermined locations. Each of said holes is 18 inches in depth. Each of the poles is snug fit into a respective one of the holes and projects above the work surface to a height of 21 inches. Each of the side panels has six window apertures therethrough. Each of the window apertures is 8 inches by 4 inches with rounded corners and disposed at predetermined locations a long the longitudinal side of the respective side panel. The main panel has, in a predetermined location, a drain aperture of 3 inches by 1 inch. A pipe has a semi-circular opening. The semi-circular opening is disposed under the drain aperture and disposed upon the work surface at an angle with respect to a horizontal plane passing through the drain aperture and into and below the work surface of the work surface for draining the vermi waste from the bed. HDPE nets are provided and so dimensioned so that each one covers one of the window apertures and the drain aperture and heat sealed to the panel.

There is also provided a method for composting agricultural waste in a tetra vermi bed. This method comprises sorting out hard material, including stones and domestic animal dung from partly decomposed agricultural waste and leaching out animal urine from the partly decomposed waste by watering and precipitating out salt to less than 0.% by weight level. Layering alternately in the tetra vermi bed said partly decomposed waste and said animal dung each in 6 inch thick layers and repeating said layering method till the tetra vermi bed is almost filled to brim or alternatively filling completely with animal dung. Sprinkling water in fine spray over the contents of the tetra vermi bed till heat of the contents is positively removed and the contents of the tetra vermi bed are cooled and humidity initially is 70%-80% by weight. Checking settling down of the contents after sprinkling water and adding a layer of animal dung till the contents reach the 2 feet height of the tetra vermi bed. Measuring periodically the temperature of the contents and maintaining it to between 25° C. to 3° C. and maintaining moisture to adequate levels. Periodically checking the pH value and maintaining it to a range of 5 to 9 level. Adding calcium carbonate to the contents to raise the pH to the 5 to 9 level or adding peat moss to the contents to lower pH to the required 5-9 pH level, the ideal pH being a pH of 7 indicating a slightly alkaline nature, which is favorable for reproduction of worms. Making 3 to 4 inch deep basins into the contents along all sides of the tetra vermi bed, after it is sufficiently cooled down and the water content comes down to 20-30% by weight so as the waste to become sufficiently moist and porous for free movement of earthworms. Adding earthworms to said basins, allowing them to mix with the contents and closing said basins. Repeating the method after three days, as described above but to add proper feed for worms. Frequently watering the contents for maintaining the porousness of the decomposed waste to facilitate free movement of worms. Allowing the earthworms for a period of 2 months to work on the partly-decomposed agricultural waste. collecting vermi wash liquid in the container placed in the pit. Periodically inspecting said vermi wash liquid, earthworms and the tetra vermi bed and monitoring temperature. Gathering the produced manure, after 40 days, from all sides of the tetra vermi bed and stacking it in a pile, leaving thereby the earthworms at bottom of the tetra vermi bed. Sieving the produced manure and packing it in bags. Sampling the packed manure for inspection for quality check. Re-using earthworms segregated from the produced manure in following manure production batches.

There is provided an apparatus of the type which is disposed upon a work surface and receives vegetation for composting. The apparatus comprises a container having a bottom and sidewalls made of flexible material. There is also means for supporting the container with respect to the work surface. The container has an open position for receiving, storing, and composting vegetation and a closed position for transportation between work surfaces.

There is also provided a method of composting partially decomposed vegetation in a compost container comprising the steps of: providing the partially decomposed vegetation providing dung; placing within the compost container the partially decomposed vegetation and dung in alternating layers; spraying the combination of decomposed vegetation and dung with water so as to reduce the temperature of the contents of the container; maintaining the water content of the compost container with a predetermined range; refilling the container as the contents of the container from time-to-time as the contents thereof settle; maintaining the contents of the container within a range of predetermine temperature and moisture content; measuring and maintaining the pH of the contents of the container at a predetermined level; add earthworms to the contents within the container; and removing the manure formed thereby after a predetermined period of time.

### BRIEF DESCRIPTION OF THE DRAWING

In order that the device and method may be more fully understood it is described by way of examples and with reference to the accompanying drawings in which:

FIG. 1 is a perspective view of a tetra vermi compost container;

FIG. 2 is a plan view of a blank of the tetra vermi compost container of FIG. 1;

FIG. 3 is a plan partial view of a front sidewall of the tetra vermi compost container of FIG. 1;

FIG. 4 is a perspective partial view a first end sidewall and a rear sidewall of the tetra vermi compost container of FIG. 1 with an extending drain pipe and receptacle therefor;

FIG. 5 is a partial plan view of the front sidewall and a rear sidewall joined to the blank of FIG. 2;

FIG. 6 is a perspective partial view of a base wall and the front side and the first end sidewall of the tetra vermi compost container of FIG. 1;

FIG. 7 is a plan view of the first end sidewall of the tetra vermi compost container of FIG. 1;

FIG. 8 is a perspective partial view of the interior of the rear sidewall and a second end sidewall of the tetra vermi compost container of FIG. 1;

FIG. 9 is a plan partial view of the front sidewall of the tetra vermi compost container of FIG. 1;

FIG. 10 is a plan partial view the first end sidewall of the tetra vermi compost container of FIG. 1 with a support member;

FIG. 11 is a plan partial view of the front sidewall of the tetra vermi compost container of FIG. 1;

FIG. 12 is a plan view of front sidewall of the tetra vermi compost container of FIG. 1;

FIG. 13 is a perspective partial view of the first end side and front sidewalls of the tetra vermi compost container of FIG. 1; and

FIG. 14 is a schematic perspective view of the support members disposed for supporting the tetra vermi compost container of FIG. 1.

### DETAILED DESCRIPTION

Described is a tetra vermi compost container which is relatively light, easily erected for use and collapsed for transportation or storage when not in use and the method for making and using the same.

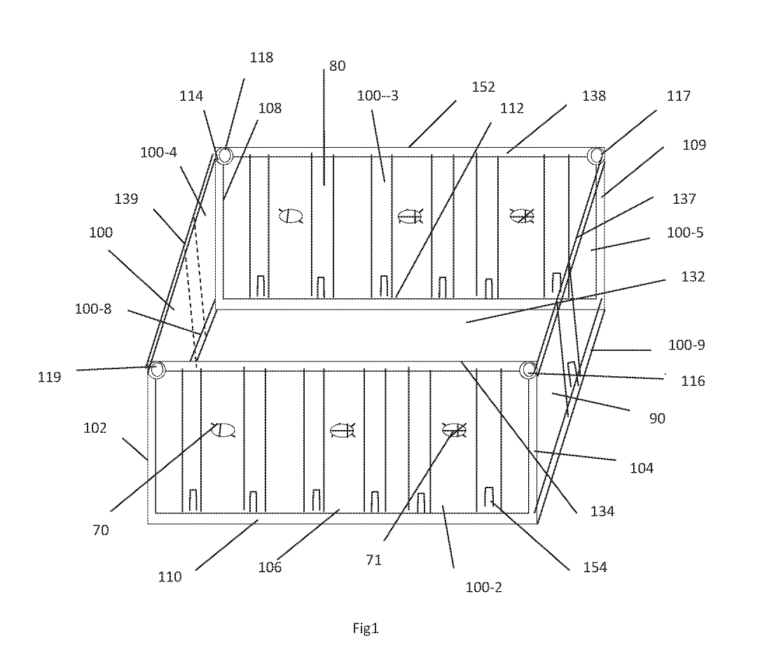

A compost container is provided which may be of any convenient shape. In this example, the compost container 100 (FIG. 1) has a substantially rectangular cross-section with a front sidewall or panel 100-2, a rear sidewall or panel 100-3, first and second end walls or panels 100-4, 100-5 and a bottom wall or panel 90. The side opposed bottom wall 90 is open to receive the vegetation for composting.

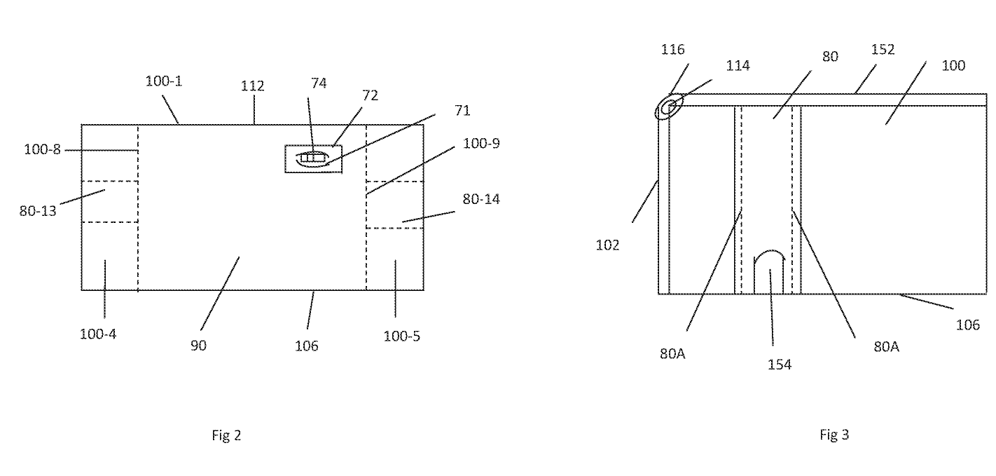

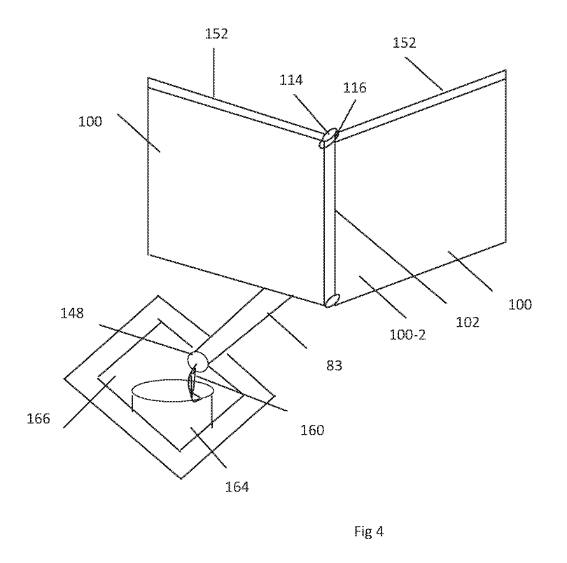

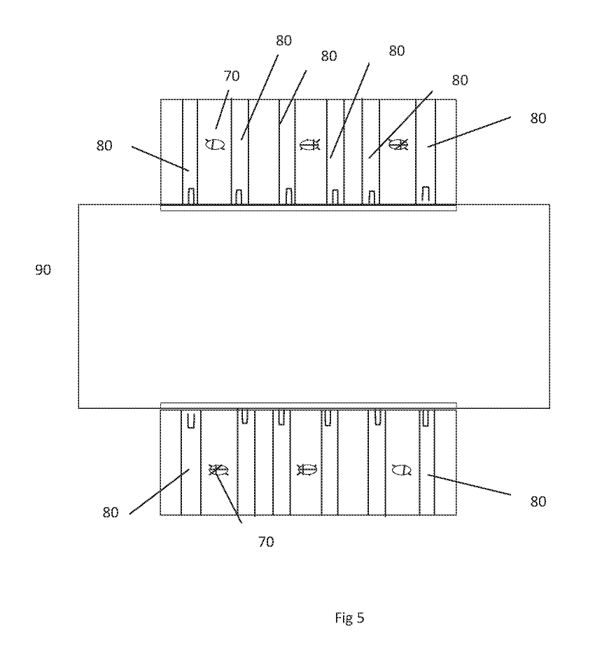

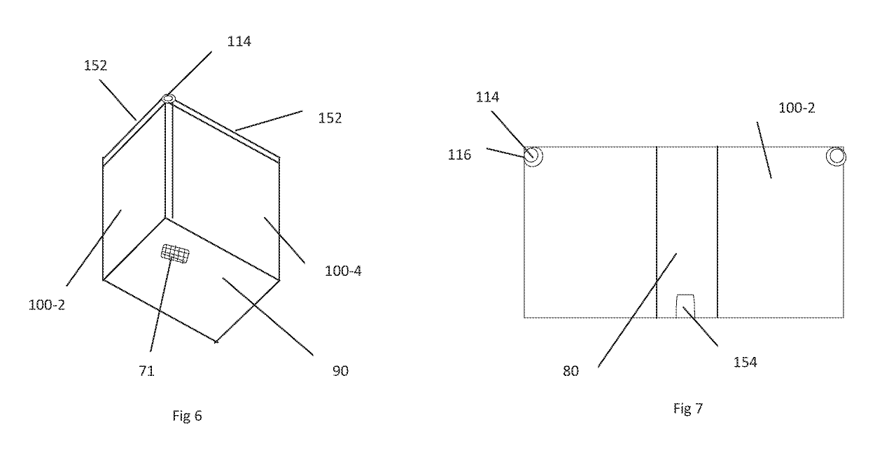

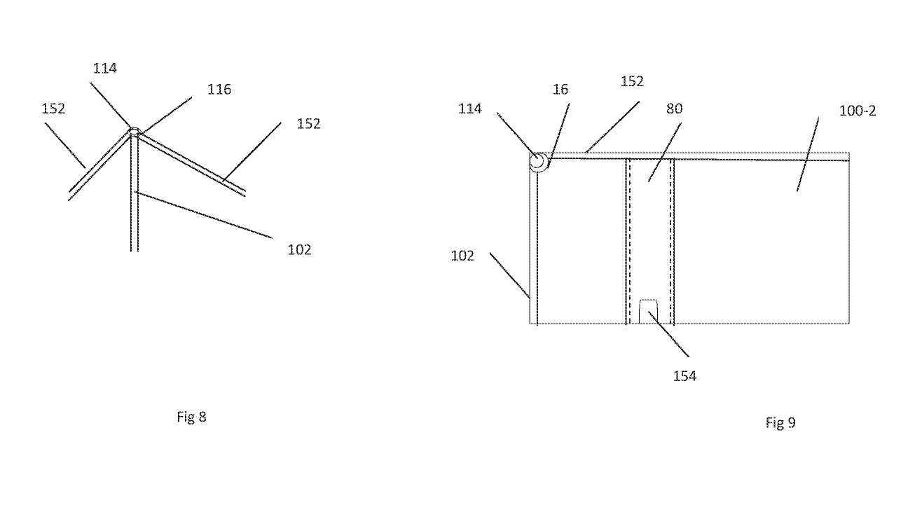

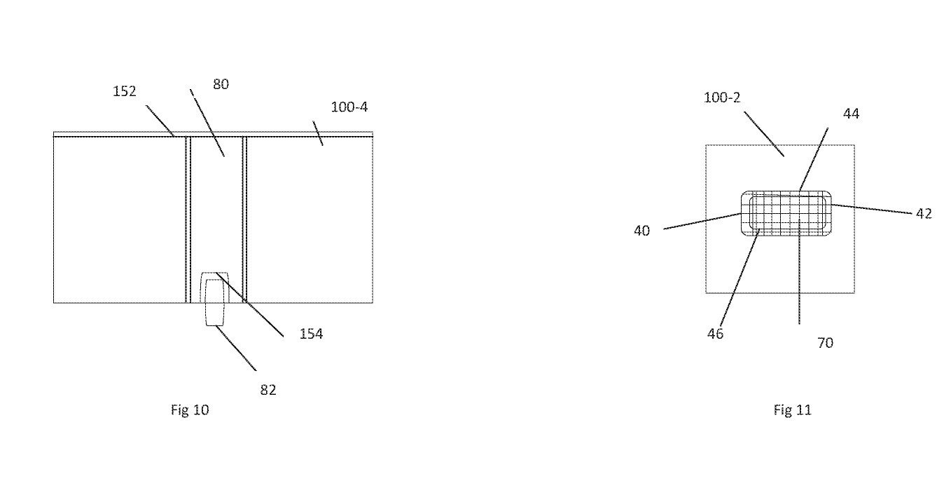

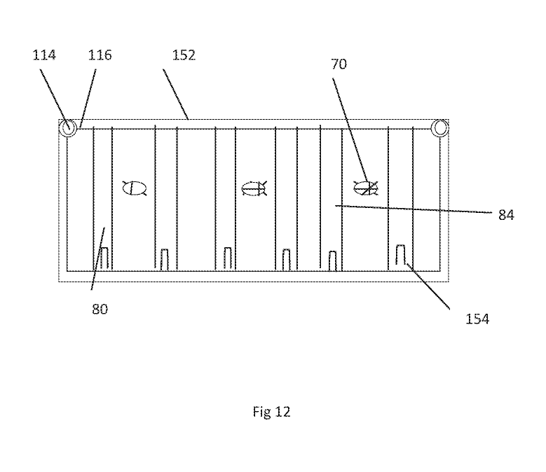

The bottom wall 90 and the first and second end walls 100-4, 100-5 may be formed from a single blank 100-1 (FIG. 2). The first and second end walls 100-4, 100-5 are formed from the blank 100-1 by folding along parallel fold-lines 100-8, 100-9 so that each end wall 100-4, 100-5 is substantially perpendicular with respect to the remainder of the blank 100-1 leaving the base wall 90 (FIGS. 1, 2, 6).

The first and second end walls 100-4, 100-5, the front side and rear sidewalls 100-2, 100-3 and the bottom wall 90 may be constructed from a material, such as a fabric, that is significantly lighter relative to such other types of materials frequently used to form a compost container, such as wood or metal. In this example, the fabric is a seven-layer chemically treated U.V.-stabilized composite woven fabric. Each layer of the fabric may comprise a laminated sandwich of a layer of LDPE between two layers of HDPE (the layered construction is not shown). Each HDPE layer may be made from HDPE granules combined with a UV stabilizing compound which is then extruded in a manner well known in the art into the single composite fabric. The UV-stabilizing compound may comprise between 3 to 5% by weight of the HDPE so as to inhibit cracking due to exposure to sunlight.

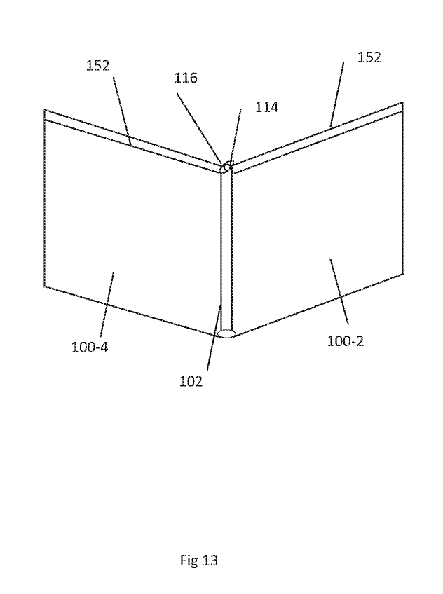

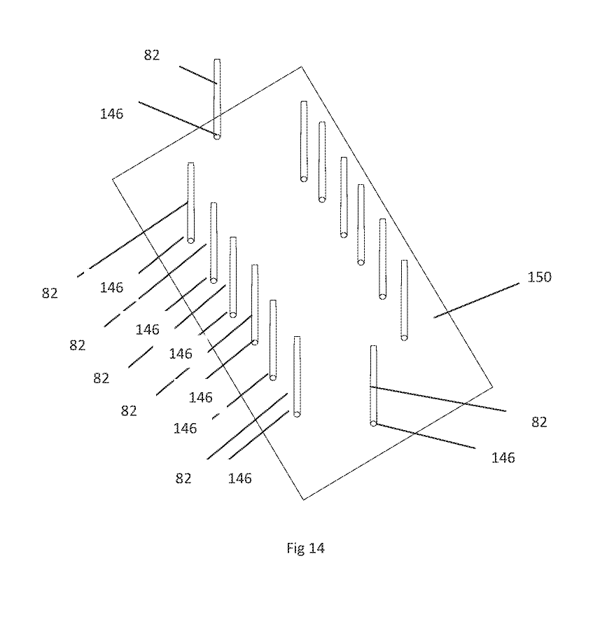

In the assembly of the container 100 the edges of adjacent walls: 100-2 and 100-4; 100-2 and 100-5; 100-3 and 100-4; 100-3 and 100-5; 100-2 and 90; and 100-3 and 90 are secured to one another by any well known means, such as adhesive or, as in this example, by heat sealing. Thus, a first marginal edge 102 of the front sidewall 100-2 is substantially perpendicular to the bottom wall 90 and is affixed to a first marginal edge 102 of the first end wall 100-4 (where a common edge is shown a single identification number is used). A second marginal edge 104 of the front sidewall 100-2, which is opposed to the first perpendicular edge 102, is affixed to a marginal edge 104 of the second side panel 100-5. A marginal edge 106 of the front sidewall 100-2, which joined to a first marginal edge 106 of the bottom wall 90 (FIGS. 1, 2, 5, 13).

A first marginal edge 108 of the rear sidewall 100-3, which is substantially perpendicular to the bottom wall 90, is joined to a second substantially perpendicular marginal edge 108 of the first end wall 1004. A second marginal edge 110 of the rear sidewall 100-3, which is opposed to its first marginal edge 108 is joined to a second marginal edge 110 of the second end sidewall 100-5 (FIGS. 1, 4, 6). A marginal edge 112 of the rear sidewall 100-3 disposed substantially coplanar with the bottom wall 90, is joined to a second marginal edge 112 of the bottom wall 90 (FIGS. 1, 4-6).

The front side and rear side and first and second end sidewalls 100-2-100-5 may be of equal perpendicular length with respect to the bottom wall 90. The sides of the front side and rear sidewalls 100-2, 100-3 which are parallel to the base wall 90 are of substantially equal length. The length of the end walls 100-4, 100-5 between their respective perpendicular edges 102 and 108, 104 and 110 are substantially equal but are shorter than the length of the front side and rear sidewalls 100-2, 100-3 between their respective perpendicular edges 102 and 104, 108 and 110. The bottom, front side, and rear sidewalls 90, 100-2, 100-3 may be each 16 feet 9 inches wide by 4 feet 2 inches high. The first and second end panels 100-4, 100-5 may each be 12 feet 9 inches by 2 feet by 4 feet 2 inches.

The front side 100-2, rear side 100-3, and first and second end walls 100-4, 100-5 may each have two apertures or eyelets 114 therethrough (FIG. 3, 7, 9, 12). Each eyelet 114 is located proximate the corner formed by the juncture of a perpendicular edge (e.g., 102 of the front sidewall 100-2) with the exposed marginal edge (e.g., 136 of the front sidewall 100-2) of the container 100.

Rope 152 may be secured to each of the top edges 136-142 of the walls 100-2-100-5, at the open end 132 of the container 100. The rope 152 may be secured by any well known means, such as adhesive (FIGS. 1, 3, 4, 6, 8, 9, 10, 12, 13). Alternatively and well known in the art, there may be provided a hem made in the walls 100-2-100-5 at the open end 132 of the container 100 and the rope 134 threaded through the hem (not shown).

Each corner of the container 100 may be provided with a flap 150 of a fabric which is attached to the abutting walls 100-2 and 100-4, 100-2 and 100-5, 100-3 and 100-4, and 100-3 and 100-5 as by heat sealing and have a grommet aperture 154 therethrough (FIGS. 1, 3, 6, 8, 13). Each of the two free rope ends (not shown) attached to each marginal edge of the side and end walls 100-2-100-5 is passed through adjacent grommet aperture and through the proximately disposed apertures 114 thereunder and tied to one another in order to strengthen the joinder of the walls 100-2 and 100-5, 100-2 and 100-4, 100-3 and 100-4, and 100-3 and 100-5.

The front side and rear sidewalls 100-2, 100-3 may have several window apertures 70 (FIGS. 1, 5, 11, 12) therethrough and spaced along the length parallel to the bottom wall 90 and adjacent but spaced from its respective top edges 134, 136. The window apertures 70 serve to vent the container 100 so as to admit fresh air and vent accumulated gases. Each window aperture 70 may be of any desired shape and size. In this example there are three substantially rectangularly shaped window apertures of equal dimensions and equally spaced along each wall 100-2, 100-3. One pair of opposed sides 44, 46 (FIG. 11) of each window 70 may be straight and parallel and the shorter dimensioned pair of sides 40, 42 may be mirror-imaged and concave (FIG. 11). A net or screen 72 may be attached to the wall as by heat sealing and cover each window 70. In this example, the net 72 is made of HDPE.

As compost decomposes within a container, it is desirable to drain the accumulated leachate or vermi wash therefrom. As with the window apertures 70, a similarly shaped drain aperture 74 is provided in the bottom wall 90 (FIG. 2) and is likewise covered with an HDPE net 72.

To effect the drainage the tetra vermi compost container 100 is supported above a work surface 156 (FIG. 14). In this example the work surface 156 is at an acute angle with respect to a horizontal plane. The work surface 156 may comprise, for example, firmly packed soil and have a gradient of 6 inches over 12 feet.

The tetra vermi compost container 100 may be provided with a multiplicity of support pockets 80 each of which is so dimensioned as to be capable of receiving support members 82 (FIGS. 1-3, 5, 7, 9, 10, 12, 14). In this example, there are fourteen such pockets 80: six each secured to the front and rear sidewalls 100-2, 100-3 and one each secured to the first and second end walls 100-4, 100-5. Each support pocket 80 may be substantially identically dimensioned. The exterior wall 84 of each support pocket 80 may be made of the same fabric as that of the blank 100-1 and front and rear sidewalls 100-2, 100-3. Each pocket 80 is secured to an exterior side 86, 88, 92, 94 of the respective front and rear sidewalls 100-2, 100-3, and first and second end walls 100-4, 100-5 by any well known means such as stitching, adhesive or, as in this example, by heat sealing. Each support pocket 80 is created by heat sealing the pocket's exterior wall 84 along its opposed and parallel marginal sides 80-A. These sides 80-A extend perpendicularly to the bottom wall 90. The exterior wall 84 of the pocket 80 and the exterior side 86-94 of each wall 100-2-100-5, respectively, form the pocket. Each pocket 80 may be joined at its edge 116 to and at edge 116-120 opposed to and parallel the bottom wall 90. Alternatively, it may have its exterior wall 84 extend over the rope 152 and then heat sealed to the interior surface of the wall (not shown).

To facilitate ease of receiving the support pole 82 the exterior wall 84 of each support pocket 80 may be disposed with its pocket opening 154 proximate the bottom wall 90 and in which the outer wall of each pocket has an U-shaped indent 154 at its opening to facilitate receiving the support members. Six of the support pockets 80 are secured to the exterior of the front side and rear side walls 100-2, 100-3. Each of the two remaining pockets 80 is secured to a respective first and second end walls 100-4, 100-5. Six of the pockets 80 are secured to the front side and to the rear side walls 100-2, 100-3 and are upon such wall 100-2 or 100-3 equally spaced from each other and equally spaced from the perpendicular edges 102 and 104, 108 and 110 of the walls. In this way each pocket 80 secured to the front side wall 100-2 is in registry with a pocket 80 secured to the rear side wall 100-3. The pocket 80 secured to the exterior of the first end wall 100-4 is in registry with the pocket secured to the exterior of the second end wall 100-5.

In this example, the opening 148 of each support pocket 80 may be 6 inches or greater between the marginal edges 80-A such that the cylindrical pole 82, which may have a 12 inch diameter, easily fits through the U-shaped indented opening 148 and into the pocket 80.

The work surface 150 may comprise, for example, firmly packed soil and provide a gradient of 6 inches over 12 feet. Alternatively, the acute angle or gradient may be obtained by varying the lengths of the poles 82 with respect to a substantially horizontal work surface (not shown) to establish the desired acute angle. As an alternative, the pockets 80 may be disposed at an acute angle along the container sidewalls 100-2-100-5 with respect to the horizontal plane such that, with support being provided by poles 82 of equal length, the container 100 will be at the acute angle with respect to the horizontal plane.

The tetra vermi container 100, when fully erected, may, because of its fabric walls, be folded upon itself and erected ready for use at a work site.

In operation, holes are made in the work surface 150 to a sufficient depth that each pole 82 is firmly in place as by grouting. In this example, there are fourteen holes 146 are made in the work surface 150 (FIG. 14) each hole 146 is so dimensioned as to be capable of receiving one of the wooden poles 82. Each hole 146 corresponds to the location of one of the pockets 80 when the container 100 is positioned over the holes. Each hole 146 has a depth of 18 inches. Each pole 82 may be of any structural material such as wood and have any desired shape such as a circular cross-section and be 40 inches in length. The insertion of the free end of all of the poles 82 into the corresponding pockets 80 thereby provides the support for the four sides 100-2-100-5 of the tetra vermi compost container 100 (FIG. 2).

A drain pipe 96, which may be made of any structural material such as plastic, and in this example is made of HDPE. The pipe 96 may have a semi-circular sector 148 aperture therein adjacent one end 168 to receive the leachate or vermi wash drained from the container 100. The pipe 82 may be fitted under the drain aperture 74 in a manner well known in the art. The other end 160 of the pipe 82 may then open into a pit 164 in the work surface 150 into which is placed a receptacle 162 (FIG. 4) to receive the vermi wash liquid. The drain aperture 74 may be positioned at the lowest point of the gradient of the work surface 150.

There is provided the process for composting partly decomposing agricultural waste in a tetra vermi bed or container of the type having a drain for removing the leachate or vermi wash. The method comprises:
providing partly decomposing agricultural waste for composting in the bed;
providing a predetermined amount of domestic animal dung;
removing from the partly decomposing agricultural waste, such as stones and domestic animal dung from the partly decomposed agricultural waste;
watering the partly decomposed agricultural waste and precipitating out salt to less than 0.5% by weight to thereby leach out any animal urine in the waste;
placing alternate layers, each of 6 inches, of the partly decomposed agricultural waste and the animal dung in the bed until the bed is substantially filled to its brim or, if there is insufficient partly decomposed agricultural waste to completely fill the bed, then filling the empty balance the bed with the animal dung;
sprinkling water in fine spray over the contents of the bed until the heat of is reduced to the ambient temperature and the humidity is between 70% and 80% of weight of the contents;
adding the animal dung to the bed to 2 feet from the brim of the bed to replace any settling of the contents;
measuring the temperature of the contents at predetermined intervals;
maintaining the temperature of the contents between 25° C. to 35° C.;
maintaining moisture to predetermined levels;
measuring the pH of the contents at predetermined intervals;
maintaining the pH of the contents to between 5 and 9 and as close to 7.5 by adding either calcium carbonate to raise the pH or peat moss to lower the PH;
making a trench or basin of between 3 to 4 inches deep in the contents proximate each sidewall and end wall of the bed when the temperature of the contents has cooled to the ambient temperature and the water is between 20% and 30% by weight of the contents so that the contents are sufficiently moist and porous for free movement of earthworms;
providing a predetermined amount of earthworms;
adding the earthworms into the basins;
allowing the earthworms to enter into the contents;
closing the basins;
waiting three days and then repeating the step of making a trench or basin of between 3 to 4 inches deep in the contents proximate each sidewall and end wall of the bed when the temperature of the contents has cooled to the ambient temperature and the water is between 20% and 30% by weight of the contents so that the contents are sufficiently moist and porous for free movement of earthworms;
providing feed for the earthworms;
adding the feed to the basins;
closing the basins;
watering the contents at predetermined intervals to maintain the porousness of decomposing agricultural waste so to facilitate free movement of the earthworms;
collecting the leachate from the drain;
inspecting the leachate, earthworms and bed and monitoring temperature at predetermined intervals;
allowing the earthworms a period of up to 2 months to work on the partly-decomposed agricultural waste;
gathering the produced manure after 40 days from the sides of the bed;
stacking the collected manure in a pile,
leaving the earthworms at bottom of the bed;
sieving the stacked manure and packing it in bags;
sampling the packed manure for inspection and quality; and
reusing the earthworms

As a further example of the apparatus, there can be provided a main panel with the following specification:
two inverted pockets having U-shaped opening, each being 24 inches by 8 inches;
a drain of 3.5 inches by 1.5 inches; and
the top opening edge have a rope of 2 inch diameter attached thereto.

What is claimed is:

1. A vermi composting bed for receiving therein waste and of the type disposed upon a work surface of dirt or soil for composting and from which is drained vermi wash or leachate, comprising:
a) a stitchless, heat-sealed, composite fabric, said composite fabric comprises four layers of UV-stabilized LDPE layers coated for heat extrusion and three HDPE substrate layers of woven fabric layers; each of said HDPE layers is disposed between two of said LDPE layers;
b) a main panel made of said fabric and being 16 feet, 9 inches, by 2 feet;
c) two end panels foldable at opposed ends of said main panel;
d) two side panels of said fabric, each being 12 feet, 9 inches, by 2 feet; said main panel, two side and end panels in combination defining the bed and being 12 feet in length by 4 feet wide by 2 feet high with an internal volume of 96 cubic feet and open at one end for receiving therein the waste for composting;
e) the exterior surfaces of said side and end panels being green and the interior surfaces of the bed being snow white;
f) rope disposed along and secured to each of the upper longitudinal marginal edge of each of said panels; said upper longitudinal marginal edges of said panels defining said opening;
g) fourteen pockets; said pockets each comprising an outer wall made of said composite fabric and secured to said exterior walls of said panels; each of said pockets having an opening proximate said bottom panel and said pocket outer wall having a U-shaped indent and said pocket closed at the end opposed to said opening; said closed end being securable to said panel at least proximate said rope;
h) fourteen round, straight, 39 inch long wooden poles; the work surface having holes at predetermined locations; each of said holes being 18 inches in depth; each of said poles being snug fit into said holes and projecting above the work surface to a height of 21 inches;
i) each of said side panels having six window apertures therethrough; each of said window apertures being 8 inches by 4 inches with rounded corners and disposed at predetermined locations a long the longitudinal side of said respective side panel;
j) said main panel having, in a predetermined location, a drain aperture of 3 inches by 1 inch;
k) a pipe having semi-circular opening; said semi-circular opening of said pipe being disposed under said drain aperture; said pipe being disposed upon the work surface at an acute angle with respect to a horizontal plane passing through said drain aperture and into and below the work surface so as to be capable of draining the leachate or vermi wash from the bed; and
l) HDPE nets being heat sealable to a panel, each being so dimensioned as to cover one of said window apertures and said drain aperture.

2. A vermi composting bed as recited in claim 1, wherein twelve of said pockets are 24 inches by 8 inches; and two sets of six of said pockets being heat-sealed to opposed respective one of said side panels and perpendicular to said longitudinal axis of said side panel.

3. A vermi composting bed as recited in claim 1, wherein at least one of said pockets being 24 inches by 8 inches; said main panel comprising two lateral side panels; one said pockets being heat-sealed to said exterior surface to each of said lateral sides parallel to the longitudinal axis of said main panel.

4. A stitchless, heat-sealed, HDPE substrate-tetra LDPE-layered, vermi composting bed as recited in claim 1, wherein each of said pockets is heat sealed at two opposed sides along the length thereof providing a 6 inch clearance along the entire length of said pockets.

5. A stitchless, heat-sealed, HDPE substrate-tetra LDPE-layered, vermi composting bed as recited in claim 2, wherein each of said pockets is heat sealed at two opposed sides along the length thereof providing a 6 inch clearance along the entire length of said pockets.

6. A stitchless, heat-sealed, HDPE substrate-tetra LDPE-layered, vermi composting bed as recited in claim 3, wherein each of said pockets is heat sealed at two opposed sides along the length thereof providing a 6 inch clearance along the entire length of said pockets.

7. A stitchless, heat-sealed, HDPE substrate-tetra LDPE-layered vermi composting bed as recited in claim 1, wherein:
(i) each of said side panel at an un-roped longitudinal side being heat sealed to a longitudinal side of said main panel;
(ii) the two lateral sides of each of said side panel being heat-sealed to the longitudinal sides of said main panel to form substantially vertical corner joints with respect to said main panel that are rope folded sideways by 2 inches and sealed over folds for additional strength.

8. A vermi composting bed as recited in claim 1, wherein:
(i) each of said window apertures is spaced 4 inches from an adjoining one of said pockets; and
(ii) at least one of said pockets is spaced 5 inches from said vertical corner joint.

9. A vermi composting bed as recited in claim 1 wherein each said outer walls of each said pocket is heat-sealed along the transverse sides to said main panel thereof to one of said panels to thereby form between said outer wall and said panel a pocket space and at said closed end opposed to said open end is anchored over said rope and heat sealed to the interior wall of said panel.

10. A vermi composting bed as recited in claim 3 wherein each said outer walls of each said pocket is heat-sealed along the transverse sides to said main panel thereof to one of said panels to thereby form between said outer wall and said panel a pocket space and at said closed end opposed to said open end is anchored over said rope and heat sealed to the interior wall of said panel.

11. A vermi composting bed as recited in claim 2 wherein each said outer walls of each said pocket is heat-sealed along the transverse sides to said main panel thereof to one of said panels to thereby form between said outer wall and said panel a pocket space and at said closed end opposed to said open end is anchored over said rope and heat sealed to the interior wall of said panel.

12. A vermi composting bed as recited in claim 1, wherein:
(a) the work surface having a gradient of 6 inches over 12 feet;
(b) fourteen said holes each having dimensions of 3 inches for receiving one of said wooden poles within a work surface area of 15 feet by 6 feet;
(c) all of said pockets of said bed for receiving said wooden poles by sliding said poles substantially simultaneously therein; and
(d) the work surface having a drain cup receiving hole; a drain cup disposed in said drain cup receiving hole; said drain pipe free end dispensing being so positioned such that the vermi wash or leachate is received by said drain cup.

13. A process for composting partly decomposing agricultural waste in a tetra vermi bed or container having a drain for removing vermi wash or leachate, comprising:
(i) providing partly decomposing agricultural waste for composting in the bed;
(ii) providing a predetermined amount of domestic animal dung;
(ii) removing from the partly decomposing agricultural waste, such as stones and domestic animal dung from the partly decomposed agricultural waste;
(iii) watering the partly decomposed agricultural waste and precipitating out salt to less than 0.5% by weight to thereby leach out animal urine;
(iv) placing alternate layers each of 6 inches of the partly decomposed agricultural waste and the animal dung in the bed until the bed is substantially filled to its brim or, if there is insufficient partly decomposed agricultural waste to completely fill the bed, then filling the empty balance the bed with the animal dung;
(v) sprinkling water in fine spray over the contents of the bed until the heat of is reduced to the ambient temperature and the humidity is between 70% and 80% of weight of the contents;
(vi) adding animal dung to the bed to 2 feet from the brim of the bed to replace any settling of the contents;
(vii) measuring the temperature of the contents at predetermined intervals;
(viii) maintaining the temperature of the contents between 25° C. to 35° C.;
(ix) maintaining moisture to predetermined levels;
(x) measuring the pH of the contents at predetermined intervals;
(xii) maintaining the pH of the contents to between 5 and 9 and as close to 7.5 by adding either:
a) calcium carbonate to raise the pH; or
b) peat moss to lower the PH;
(xiii) making a trench or basin of between 3 to 4 inches deep in the contents proximate each sidewall and end wall of the bed when the temperature of the contents has cooled to the ambient temperature and the water is between 20% and 30% by weight of the contents so that the contents are sufficiently moist and porous for free movement of earthworms;
(xiv) providing a predetermined amount of earthworms;
(xv) adding the earthworms into the basins;
(xvi) allowing the earthworms to enter into the contents;
(xvii) closing the basins;
(xviii) waiting three days and then repeating steps (xiii);
(xix) providing feed for the earthworms;
(xx) adding the feed to the basins;
(xxi) closing the basins;
(xxii) watering the contents at predetermined intervals to maintain the porousness of decomposing agricultural waste so to facilitate free movement of the earthworms;
(xxiii) collecting the vermi wash or leachate from the drain;
(xxiv) inspecting the vermi wash liquid, earthworms and bed and monitoring temperature at predetermined intervals;
(xxv) allowing the earthworms a period of up to 2 months to work on the partly-decomposed agricultural waste;
(xxvi) gathering the produced manure after 40 days from the sides of the bed;
(xxvi) stacking the collected manure in a pile,
(xxvii) leaving the earthworms at bottom of the bed;
(xxviii) sieving the stacked manure and packing it in bags;
(xxix) sampling the packed manure for inspection and quality; and
(xxx) reusing the earthworms.

14. A composting bed as recited in claim 1, wherein each one of said panels being joined to another of said panels to define a corner of the bed; each of said panels having therethrough least two eyelet apertures; a flap of said composite fabric having an aperture therein dimensioned so as to be registerable with one of said eyelets and being disposed about said eyelet and heated sealable to said exterior surface of one of said panels; said rope being disposed through said flaps and eyelets for engaging said walls.

15. A composting apparatus of the type which is disposed upon a work surface and receives vegetation for composting, said apparatus comprising:
a) a container having a bottom and sidewalls made of flexible material;
b) means for supporting said container with respect to the work surface; and
c) said container having an open position for receiving, storing, and composting vegetation and a closed position for transportation between work surfaces.

16. A composting apparatus as recited in claim 15 further comprising means for supporting said container in said open position upon the work surface so that said container is, in said open position, capable of receiving and retaining therewithin the vegetation for composting.

17. A composting apparatus as recited in claim 16 wherein said fabric comprises a chemically treated U.V.-stabilized composite woven of fabric layers extruded to form a single fabric.

18. A composting apparatus as recited in claim 17 wherein said fabric further comprises at least one layer of a laminated sandwich of a layer of LDPE disposed between two layers of HDPE.

19. A composting apparatus as recited in claim 18 wherein each of said HDPE layers comprise HDPE granules and a UV stabilizing compound and wherein said layers are extruded into the single composite fabric.

20. A composting apparatus as recited in claim 19 wherein said UV-stabilizing compound comprises between 3 to 5% by weight of the HDPE.

21. A composting apparatus as recited in claim 20 wherein said fabric comprises seven of said sandwiched layers and extruded to form said fabric.

22. A composting apparatus as recited in claim 16 further comprises means secured to said sidewalls of said container for releasably receiving said support means.

23. A composting apparatus as recited in claim 22 wherein said container, substantially without any vegetation therein and said receiving means not engaged with said support means, said container is foldable into said closed position.

24. A composting apparatus as recited in claim 23 wherein said receiving means comprises at support pockets secured to the exterior of said sidewalls and said supporting means comprises substantially rigid poles removably insertable into said support pockets for supporting said container above the work surface.

25. A composting apparatus as recited in claim 24 wherein said container is supported at an acute angle with respect to a horizontal plane and the work surface is coplanar with said horizontal plane.

26. A composting apparatus as recited in claim 25 wherein said poles are each of equal length and the work surface is at said acute angle with respect to said horizontal plane.

27. A composting apparatus as recited in claim 25 wherein said poles may be of different lengths such that said container is supported at an acute angle with respect to a horizontal plane.

28. A composting apparatus as recited in claim 25 wherein said poles are of equal lengths and said pockets are secured to said walls of said container such that said container is at an acute angle with respect to a horizontal plane.

29. A composting apparatus as recited in claim 16 wherein said sidewalls have therethrough at least one vent window aperture for admitting air into said container and for venting accumulated gases from said container.

30. A composting apparatus as recited in claim 29 further comprises a multiplicity of vent windows each having a net covering said vent windows.

31. A composting apparatus as recited in claim 25 wherein said bottom wall has a drain aperture therein having a net covering.

32. A composting apparatus as recited in claim 31 wherein said bottom wall is substantially planar; said drain being positioned such that when said bottom wall is disposed at said acute angle with respect to said horizontal plane, said drain being disposed at substantially the lowest declination of said bottom wall with respect to said horizontal plane.

33. The method of composting partially decomposed vegetation in a compost container comprising the steps of:
a) providing the partially decomposed vegetation;
b) providing dung;
c) placing within the compost container the partially decomposed vegetation and dung in alternating layers;
d) spraying the combination of decomposed vegetation and dung with water so as to reduce the temperature of the contents of the container;
e) maintaining the water content of the compost container with a predetermined range;
f) refilling the container as the contents of the container from time-to-time as the contents thereof settle;
g) maintaining the contents of the container within a range of predetermine temperature and moisture content;
h) measuring and maintaining the pH of the contents of the container at a predetermined level;
i) add earthworms to the contents within the container; and
j) removing the manure formed thereby after a predetermined period of time.

34. The method of composting as recited in claim 33 wherein the step of providing the partially decomposing vegetation comprises removing foreign objects and dung from the partially decomposing vegetation and precipitating urine from the partially decomposing vegetation to a predetermined level.

35. The method of composting as recited in claim 34 wherein the step of providing the partially decomposed vegetation and dung in alternating layers comprises filling the container until full.

36. The method of composting as recited in claim 35 wherein the step of spraying the combination of decomposed vegetation and dung with water further comprises maintaining the contents of the container within a predetermined range of moisture.

37. The method of composting as recited in claim 36 where in the step of removing the manure formed within the container comprises leaving the earthworms in the container and removing the earthworms for later use in composting.

38. The method of composting as recited in claim 37 wherein the step of providing partially decomposing vegetation includes precipitating urine from the partially decomposing vegetation such that the salt content thereof is less than 0.5% of the level weight of the partially decomposing vegetation.

39. The method of composting as recited in claim 38 the step of maintaining the contents of the compost container within a predetermined range of moisture comprises maintaining the water content of the compost container between 70% to 80% of the weight of the contents.

40. The method of composting as recited in claim 39 wherein the step of measuring and maintaining the pH of the contents of the container at a predetermined level comprises maintaining the pH between 5 and 9.

41. The method of composting as recited in claim 40 wherein the step of maintaining the pH within a range 5 and 9 further comprises:
a) providing calcium carbonate;
b) adding the calcium carbonate to the contents of the container for increasing the pH of the contents to keep the contents within the range of 5 to 9;
c) providing peat moss; and
d) adding peat to the contents of the content to lower the pH to within the range of 5 to 9.
